(19) United States
(12) Patent Application Publication
(10) Pub. No.: US 2025/0220309 A1
(43) Pub. Date: Jul. 3, 2025

(54) METHOD AND DEVICE FOR INTELLIGENTLY SELECTING THE FIELD OF VIEW OF CAMERAS ON A MACHINE TOOL

(71) Applicant: TRUMPF Werkzeugmaschinen SE + Co. KG, Ditzingen (DE)

(72) Inventors: Korbinian Weiss, Korntal (DE); Willi Pönitz, Leonberg (DE); Marc Teschner, Stuttgart (DE); Guillem Boada, Tübingen (DE)

(21) Appl. No.: 19/083,706

(22) Filed: Mar. 19, 2025

Related U.S. Application Data
(63) Continuation of application No. PCT/EP2023/074188, filed on Sep. 4, 2023.

(30) Foreign Application Priority Data
Sep. 19, 2022 (DE) 10 2022 123 924.1

(51) Int. Cl. H04N 23/69; G06T 7/20; H04N 23/695; H04N 23/90

(52) U.S. Cl. CPC H04N 23/69; G06T 7/20; H04N 23/695; H04N 23/90

(57) ABSTRACT

A method for monitoring the manufacture of a component with a machine tool. A plurality of cameras cover different fields of view. An algorithm creates a ranking of the relevance of images from the cameras and features only the most relevant image(s) on a monitor. The algorithm can assign a higher relevance to images that: a) depict a known machine tool part that is mentioned in a status or error message; b) have a high optical flow; and/or c) depict an identified machine tool part that is moving. In the event of c), images can be successively assigned higher relevance if an identified machine tool part moves from one field of view to the next. Images assigned lower relevance may be deleted or reduced in size. The algorithm can take the form of artificial intelligence.

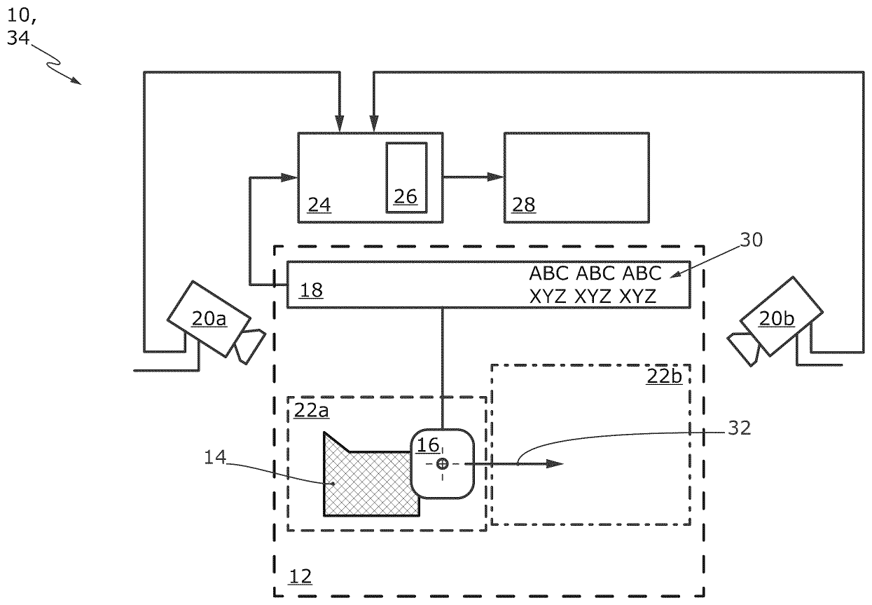

### CROSS-REFERENCE TO RELATED APPLICATION

This application is a continuation, under 35 U.S.C. § 120, of copending International Patent Application PCT/EP2023/074188, filed Sep. 4, 2023, which designated the United States; this application also claims the priority, under 35 U.S.C. § 119, of German Patent Application DE 10 2022 123 924.1, filed Sep. 19, 2022; the prior applications are herewith incorporated by reference in their entirety.

### FIELD AND BACKGROUND OF THE INVENTION

The invention relates to a method and a device for manufacturing a component.

German published patent application DE 10 2017 121 098 A1 discloses tracking a component to be manufactured through the production process. For this purpose, a plurality of cameras are provided in production, wherein the imaging camera is changed depending on the field of view of the camera in which the component is located. The location of the component can be supported by a UWB positioning system.

It has also become known to observe the production of a component in a machine tool by observing it from different fields of view or perspectives of a plurality of cameras. A user or observer of the production process can be located at a different location than the machine tool and act as a remote controller. However, it is difficult for an inexperienced user to find the relevant camera image(s) from the multitude thereof. In particular in the event of a machine tool failure, the user wants to quickly view the relevant camera image(s).

### SUMMARY OF THE INVENTION

It is therefore an object of the invention to provide a method and a device which significantly facilitate the monitoring of a machine tool.

With the above and other objects in view there is provided, in accordance with the invention, a method for manufacturing a component with a machine tool, the method comprising:
A) simultaneously creating a plurality of images of at least parts of the machine tool by a plurality of cameras with different fields of view and feeding the images into an evaluation unit with an algorithm;
B) selecting one or a plurality of relevant images by the algorithm in a computerized manner and outputting the images to a monitor, wherein a relevance of the images is determined based on one or more of the following criteria a) to c):
   a) the respective image shows an area of the machine tool, which is designated by at least one of a status message or an error message of a machine tool control system;
   b) the respective image shows a comparatively high optical flow;
   c) the respective image shows a moving part of the machine tool identified in the image.

In other words, the objects of the invention are achieved by a method for the manufacture of a component with a machine tool, wherein the following method steps are carried out:

Step A), images of at least parts of the machine tool are taken by a plurality of cameras, wherein the images are fed into an evaluation unit which has an algorithm for evaluating the images; and step B), one or more relevant images are selected by the algorithm and the relevant image(s) are output to a monitor.

The relevance of the images is determined by the following criterion or criteria:
images showing a machine tool part that is mentioned in a status message (e.g., a sensor value or an axis position) or error message of a machine tool control system are assigned a higher relevance than images showing a machine tool part that is not mentioned in a status or error message;
images that have a high optical flow are assigned a higher relevance than images that have a lower optical flow; and/or
images in which a moving machine tool part is identified are assigned a higher relevance than images in which no moving machine tool part is identified.

The method according to the invention enables a user or observer of the machine tool to concentrate on the region of interest of the machine tool. This allows even less experienced users to carry out remote maintenance of the machine tool. Errors can be analyzed and found more quickly and easily.

The method can be set up to display only the most relevant image on the monitor. Alternatively, only a few relevant images can be displayed on the monitor. Alternatively, the most relevant image or a few relevant images can be highlighted on the monitor. For example, less relevant images can be displayed smaller on the monitor.

The cameras are preferably designed as video cameras; the images are then available as video images.

The method steps A) and B) can be repeated, in particular several times. This allows a user to continuously track the region of interest in the machine tool.

Preferably, at least one of the cameras is aimed at the area of the machine tool designated by the status message and/or the error message of the machine tool control system. The aiming can be done in particular by panning and/or zooming the camera. By panning and/or zooming, the camera's field of view can be aimed particularly well at the area of interest. If a plurality of cameras are aimed at the area, it is possible to view the area from a plurality of angles. From the plurality of angles, the most relevant image can then be selected.

Particularly preferably, when applying criterion c), the algorithm predicts the field of view of the camera into which an identified machine tool part will move next and assigns a higher relevance to the associated image (of the next field of view) as soon as the identified machine tool part has left the current field of view. This allows the user to easily track a machine tool part.

The method step B) can be carried out live, i.e., with as little delay as possible after the method step A). Alternatively, the method step B) can be carried out using stored images, in particular for fault analysis of the machine tool.

To conserve resources, images with little relevance can be deleted or transmitted or stored with a reduced resolution.

In a further preferred embodiment of the invention, the algorithm is designed in the form of a machine learning algorithm. The machine learning algorithm is preferably trained using stored images that have been assigned to a specific status or error message. Alternatively or additionally, the machine learning algorithm can be trained by selecting cameras from one or more experienced users.

The monitoring of the machine tool is further facilitated if, in addition to the image(s) displayed on the monitor, a status or error message from the machine tool control system is provided, particularly on the monitor.

Furthermore, an option for interaction with the machine tool can be provided. Machine data can be shown in the images and functions can be deactivated/activated directly in the images if the situation requires it. Example: A machine tool stops with a “transport control” error. The operator is shown the relevant live image(s) directly and can restart the machine tool in the image if the error is a false alarm. This allows for much faster operation than having to switch to a control system and search for the function.

The method according to the invention is particularly suitable for use on a machine tool which is designed for laser processing, in particular for laser cutting or laser welding, of the component. Alternatively or additionally, the method can be used on an automated bending machine or a storage system.

The object according to the invention is furthermore achieved by a device for carrying out a method described here. The device has the machine tool, the cameras—in particular in the form of video cameras, the evaluation unit with the algorithm, and the monitor. Features and advantages described for the method refer accordingly to the device and vice versa.

The machine tool preferably has a laser head for laser processing of the component, in particular for laser cutting and/or laser welding.

Alternatively or additionally, the machine tool may have an automated tool changer, in particular for punching or bending machines.

Other features which are considered as characteristic for the invention are set forth in the appended claims. Further advantages of the invention arise from the description and the drawings. Similarly, the features mentioned above and the features still to be explained may each be used on their own or together in any desired combinations according to the invention. The embodiments shown and described should not be understood as an exhaustive list, but rather are of an exemplary character for describing the invention.

Although the invention is illustrated and described herein as embodied in a method and device for intelligently selecting the field of view of cameras on a machine tool, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE FIGURE

The single FIGURE of the drawing shows a schematic view of a device according to the invention and a method according to the invention.

### DETAILED DESCRIPTION OF THE INVENTION

The FIGURE shows a device 10 with a machine tool 12 for the manufacture of a component 14. To manufacture the component 14, the machine tool 12 has, among other things, a laser head 16, here in the form of a cutting head. The manufacture of the component 14 is controlled by a machine tool control system 18.

The manufacture of the component 14 is monitored by a plurality of cameras 20a, 20b, here in the form of video cameras. However, each camera 20a, b monitors its own field of view 22a, 22b. The fields of view are displayed separately here, but can also overlap. The images created by the cameras 20a, b, here in the form of videos, are fed into an evaluation unit 24. The evaluation unit 24 may be part of the machine tool control system 18. The evaluation unit 24 has an algorithm 26 which evaluates the images.

The evaluation unit 24 is configured to use the algorithm 26 to determine the most relevant images, in particular the most relevant image, and to transmit them to a monitor 28. The evaluation of the production process is made much easier for a user by the selection of the most relevant image(s). In particular, in the event of a production error, the user can focus on the relevant images on the monitor 28 and does not have to hide images of irrelevant parts of the machine tool 12.

Furthermore, the evaluation unit 24 is designed to aim the cameras 22a, 22b at the area of the machine tool 20 that is designated by a status message or an error message 30 of the machine tool control system 18. For this purpose, the cameras 22a, 22b can be panned by the evaluation unit 24 or the cameras 22a, 22b can be set to zoom.

The algorithm 26 can be designed in the form of a machine learning algorithm. The machine learning algorithm can be trained in particular on the basis of tagged stored images and/or on the basis of user behavior when selecting images.

The algorithm 26 can evaluate the relevance of the images by the following criteria a) to c):
a) assessing whether the image shows a part of the machine tool 12 for which a status and/or error message 30 is output by the machine tool control system 18;
b) determining the optical flow of the images and assigning high relevance to images with a high optical flow; and/or
c) identifying a moving part of the machine tool 12 in the images.

For example, when applying criterion c), the algorithm 26 can identify the laser head 16 in the field of view 22a and, based on the movement of the laser head 16 in the direction of an arrow 32, recognize that it will next appear in field of view 22b. As soon as the laser head 16 has left the field of view 22a, the algorithm 26 can then assign a high relevance to the field of view 22b so that the user can continue to follow the movement of the laser head 16 on the monitor 28.

The device 10 shown in the single FIGURE or a method 34 shown in the single FIGURE enables concentrated tracking of the most relevant images. Irrelevant images can be deleted or transmitted with a reduced resolution to save storage space, computing capacity, and/or bandwidth.

Looking at the drawing, the invention relates in summary to a method 34 for monitoring the manufacture of a component 14 using a machine tool 12, wherein a plurality of cameras 20a, b cover different fields of view 22a, b. An algorithm 26 can create a ranking of the relevance of images from the cameras 20a, b and display or emphasize only the most relevant image(s) on a monitor 28. The algorithm 26 can assign a higher relevance to images that a) depict a known machine tool part that is mentioned in a status or error message; b) have a high optical flow; and/or c) depict an identified machine tool part that is moving. In the event of c), images can be successively assigned higher relevance if an identified machine tool part moves from one field of view 22a, b belonging to said image to the next. Images assigned lower relevance can be deleted or displayed —and/or saved—at a reduced size. The algorithm 26 can take the form of artificial intelligence. The invention also relates to a device 10 for carrying out such a method 34.

The following is a summary list of reference numerals and the corresponding structure used in the above description of the invention:
10 Device
12 Machine tool
14 Component
16 Laser head
18 Machine tool control system
20a, b Camera
22a, b Field of view
24 Evaluation unit
26 Algorithm
28 Monitor
30 Status and/or error message
32 Direction of movement of the laser head 16
34 Method

1. A method for manufacturing a component with a machine tool, the method comprising:
A) simultaneously creating a plurality of images of at least parts of the machine tool by a plurality of cameras with different fields of view and feeding the images into an evaluation unit with an algorithm;
B) selecting one or a plurality of relevant images by the algorithm in a computerized manner and outputting the images to a monitor, wherein a relevance of the images is determined based on one or a plurality of the following criteria:
a) the respective image shows an area of the machine tool, which is designated by at least one of a status message or an error message of a machine tool control system;
b) the respective image shows a comparatively high optical flow;
c) the respective image shows a moving part of the machine tool identified in the image.

2. The method according to claim 1, which comprises repeating method steps A) and B).

3. The method according to claim 1, which comprises repeating the method steps A) and B) several times.

4. The method according to claim 1, which comprises aiming at least one of the cameras at the area of the machine tool designated by at least one of the status message or the error message of the machine tool control system.

5. The method according to claim 1, wherein the step of aiming the at least one camera at least one of panning or zooming the camera.

6. The method according to claim 2, which comprises predicting with the algorithm in criterion c) a next field of view into which the identified part of the machine tool will be moved, and rating the image of the next field of view with a high relevance as soon as the identified part has left the current field of view.

7. The method according to claim 1, which comprises carrying out method step B) with stored images.

8. The method according to claim 1, which comprises performing one of the following with an image of low relevance: deleting the image, transmitting the image with a reduced resolution, or storing the image with a reduced resolution.

9. The method according to claim 1, wherein the algorithm is a machine learning algorithm.

10. The method according to claim 1, which comprises outputting at least one of a status message or an error message of the machine tool control system for the image(s) displayed on the monitor.

11. The method according to claim 1, which comprises outputting an interaction option for controlling the machine tool on the image(s) displayed on the monitor.

12. The method according to claim 1, which comprises manufacturing the component by laser processing by the machine tool.

13. The method according to claim 12, wherein manufacturing the component comprises laser cutting of the component.

14. A device for manufacturing a component with a machine tool, the device comprising:
a machine tool, a plurality of cameras having different fields of view and being configured to simultaneously create a plurality of images of at least parts of said machine tool, and a monitor;
an evaluation unit connected to receive the images from said cameras, said evaluation unit having an algorithm configured to determine a relevance of the images created with said cameras based on one or more of the following criteria a) to c):
a) the respective image shows an area of the machine tool, which is designated by at least one of a status message or an error message of a machine tool control system;
b) the respective image shows a comparatively high optical flow;
c) the respective image shows a moving part of the machine tool identified in the image; and
said evaluation unit being configured to output relevant images selected by the algorithm to said monitor.

15. The device according to claim 14, wherein said machine tool has a laser head configured to manufacture the component by laser processing with the machine tool.

16. The device according to claim 14, wherein said machine tool has an automated tool changer.
